(19) United States
(12) Patent Application Publication
(10) Pub. No.: US 2025/0182291 A1
(43) Pub. Date: Jun. 5, 2025

(54) DIGITAL IMAGE OUTLINE GENERATION

(71) Applicant: Adobe Inc., San Jose, CA (US)

(72) Inventors: Abhishek Verma, Noida (IN); Nitesh Jain, Noida (IN); Julien Olivier Victor Philip, London (GB)

(73) Assignee: Adobe Inc., San Jose, CA (US)

(21) Appl. No.: 18/527,854

(22) Filed: Dec. 4, 2023

(51) Int. Cl. G06T 7/12; G06T 5/00; G06T 11/00; G06V 10/70; G06V 10/77; G06V 20/50; G06V 20/70

(52) U.S. Cl. CPC G06T 7/12; G06T 5/70; G06T 11/00; G06V 10/77; G06V 10/87; G06V 20/50; G06V 20/70; G06T 2200/24; G06T 2207/20192

(57) ABSTRACT

Digital image outline generation techniques that leverage context of a digital image are described. In one or more examples, an outline generation system detects a context of a digital image, e.g., using a machine-learning model to detect a context of an outdoor scene, indoor scene, presence of a salient object, and so on. The outline generation system then selects a context processing module from a plurality of context processing modules based on the detected context to generate candidate outlines that are then vectorized to generate an image outline.

### BACKGROUND

Digital images are used to convey a variety of ideas in a variety of ways. One technique to do so involves variations in a richness of content included in the digital image. A digital image of a dog, for instance, configured in a high resolution is usable to convey rich details regarding visual characteristics of the dog, e.g., to view details of the hair of the dog, eye color, and so on. On the other hand, an outline of the dog is usable to focus context of the digital image to convey emotion and other semantic concepts relating to the dog.

Conventional techniques used to vary the richness of the digital image, however, typically involve manual interaction that is prone to error, involves significant amounts of time to perform as well as skills that are oftentimes developed over a significant amount of time. Consequently, conventional techniques are inefficient and result in wasteful use of computational resources, power consumption, and are frustrating to casual users and even experienced users to realize.

### SUMMARY

Digital image outline generation techniques that leverage context of a digital image are described. In one or more examples, an outline generation system detects a context of a digital image, e.g., using a machine-learning model to detect a context of an outdoor scene, indoor scene, presence of a salient object, and so on. The outline generation system then selects a context processing module from a plurality of context processing modules based on the detected context to generate candidate outlines that are then vectorized to generate an image outline.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ digital image outline generation techniques described herein.

FIG. 2 depicts a system in an example implementation showing operation of a context detection module and a context processing unit of an outline generation system of FIG. 1 in greater detail.

FIG. 3 depicts a system in an example implementation showing operation of an indoor scene processing module of FIG. 2 in greater detail.

FIG. 4 depicts examples of generation of primary candidate outlines and secondary candidate outlines by an indoor scene processing module of FIG. 3 which are then merged to form an image outline.

FIG. 5 depicts a system in an example implementation showing operation of an outdoor scene processing module of FIG. 2 in greater detail.

FIG. 6 depicts a system in an example implementation showing operation of a salient object processing module of FIG. 2 in greater detail.

FIG. 7 depicts examples of generation of primary candidate outlines and secondary candidate outlines by an salient object processing module of FIG. 6 which are then merged to form an image outline.

FIG. 8 is a flow diagram depicting an algorithm as a step-by-step procedure in an example implementation of operations performable for accomplishing a result of generating a digital image outline from a digital image based on a context exhibited by the digital image.

FIG. 9 illustrates an example system including various components of an example device that can be implemented as any type of computing device as described and/or utilize with reference to the previous figures to implement embodiments of the techniques described herein.

### DETAILED DESCRIPTION

### Overview

Conventional techniques used to generate an outline from a digital image are prone to error and result in visual inaccuracies. Conventional outline generation techniques, for example, often involve manual inputs to edit and “clean” the outline to achieve a desired appearance. As a result, conventional techniques are inefficient and result in wasteful use of computational resources, power consumption, and are frustrating to casual users and even experienced users to implement.

Accordingly, in order to address these and other technical challenges, digital image outline generation techniques are described that support automated generation of an image outline from a digital image in real time, which is not possible in conventional techniques. Therefore, these techniques are usable to generate an image outline consistent with user expectations from a digital image by leveraging an understanding of a context in how the digital image is perceived to then select how to generate the image outline.

In one or more examples, an outline generation system receives a digital image, e.g., a bitmap image, JPEG image, PNG image, and so forth. The outline generation system then employs a context detection module to detect a context exhibited by the digital image. The context detection module, for instance, is configurable to employ a machine-learning model (e.g., a convolutional neural network) that is trained and retrained using training data to identify a respective context as a label. For example, the machine-learning model is trained using training data to generate probabilities usable to identify an indoor scene, an outdoor scene, inclusion of a salient object, and so on. Accordingly, an output of the context detection module includes one or more labels that identify a context detected for a respective digital image.

The context is then used as a basis by a context processing unit of the outline generation system to select a context processing module from a plurality of context processing modules. Each of the plurality of context processing modules are usable to generate candidate outlines from the digital image, which may be optimized to do so based on context. The context processing modules are representative of respective techniques implemented using a processing device and computer-readable storage media to generate the candidate outlines.

An indoor scene processing module, for instance, is usable to generate the candidate outlines for a digital image having a context of an indoor scene, e.g., an office, living room, and so forth. To do so in one or more examples, the indoor scene processing module first adjusts lighting values of the digital image, e.g., to promote consistent lighting of objects within the digital image. The indoor scene processing module then employs a primary outline generation module to generate primary candidate outlines, e.g., as raster objects.

The indoor scene processing module is also configured to employ a secondary outline generation module (e.g., implemented using a graphics processing unit) to generate secondary candidate outlines, e.g., also as raster objects. A vectorization module is then employed in this example to merge the primary and secondary candidate outlines, which are vectorized to generate an image outline. In this way, use of the primary and secondary outline generation modules by the indoor scene processing module increases accuracy of indoor scenes depicted by a respective digital image by capturing both primary outlines (e.g., of objects) and secondary outlines, e.g., of an environment in which the objects are disposed.

In another instance, an outdoor scene processing module is utilized to generate an image outline of a digital image for an outdoor scene context. To do so, it has been found that the outdoor scene processing module is configurable to utilize a primary outline generation module independent of use of a secondary outline generation module. In other words, the secondary outline generation module is not utilized in this scenario to generate the image outline for an outdoor scene, e.g., in order to focus on primary objects to convey a desired level of detail. As a result, computational resources are conserved by the outline generation system in this scenario while improving accuracy of the image outline over conventional techniques.

In yet another instance, a salient object processing module is employed. In this example, a primary outline generation module and a secondary outline generation module are also utilized to generate primary candidate outlines and a first set of secondary candidate outlines as previously described for the indoor scene processing module to capture different levels of detail from the digital image, respectively.

The salient object processing module also employs an object detection system that is configured to detect an object within the digital image (e.g., using a machine-learning model) to generate an object mask. The object mask is then filtered (e.g., using an erosion filter, dilation filter, and so on) in one or more examples to smooth edges of the object mask. An output of the object detection system is also used by a secondary outline generation module to generate a second set of secondary candidate outlines. The second set of secondary candidate outlines are then merged with the first set of secondary candidate outlines to form merged secondary candidate outlines. A vectorization module is also employed in this example to merge the primary candidate outlines with the merged secondary candidate outlines, which are then vectorized to generate an image outline.

Vectorization of the candidate outlines by the outline generation system in the above examples may also include removal of duplicates and noise to generate the image outline. In this way, the image outline is generated automatically and without user intervention in real time by the outline generation system as optimized based on a context detected from the digital image, which is not possible in conventional techniques. Further discussion of these and other examples is included in the following sections and shown in corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Image Outline Environment

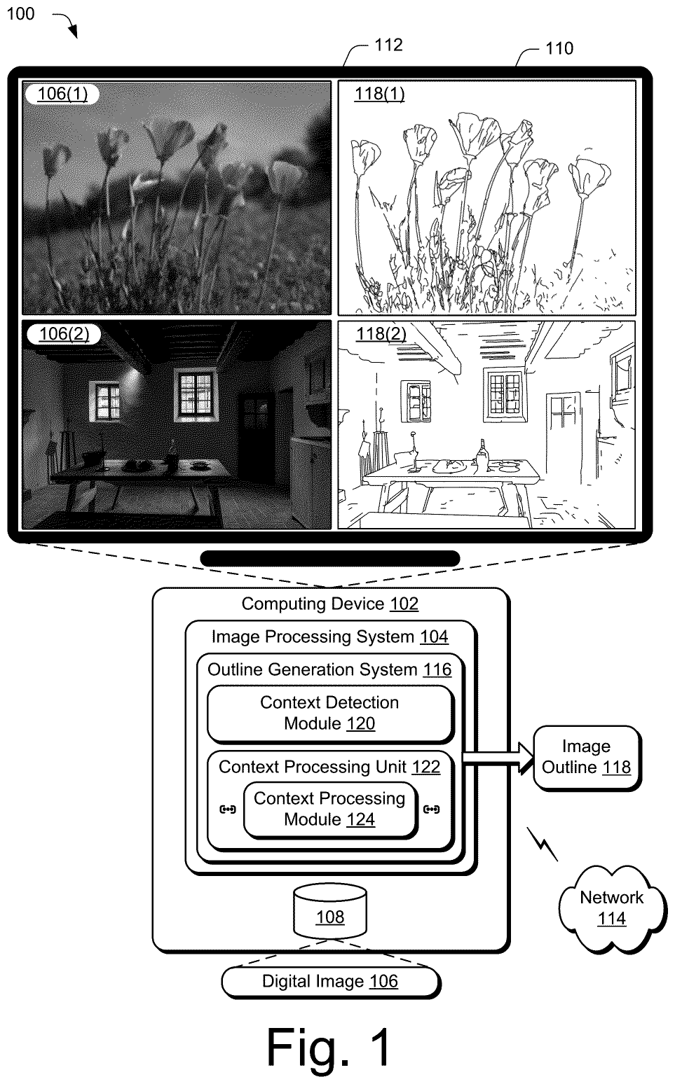

FIG. 1 is an illustration of a digital medium environment 100 in an example implementation that is operable to employ digital image outline generation techniques described herein. The illustrated environment 100 includes a computing device 102, which is configurable in a variety of ways.

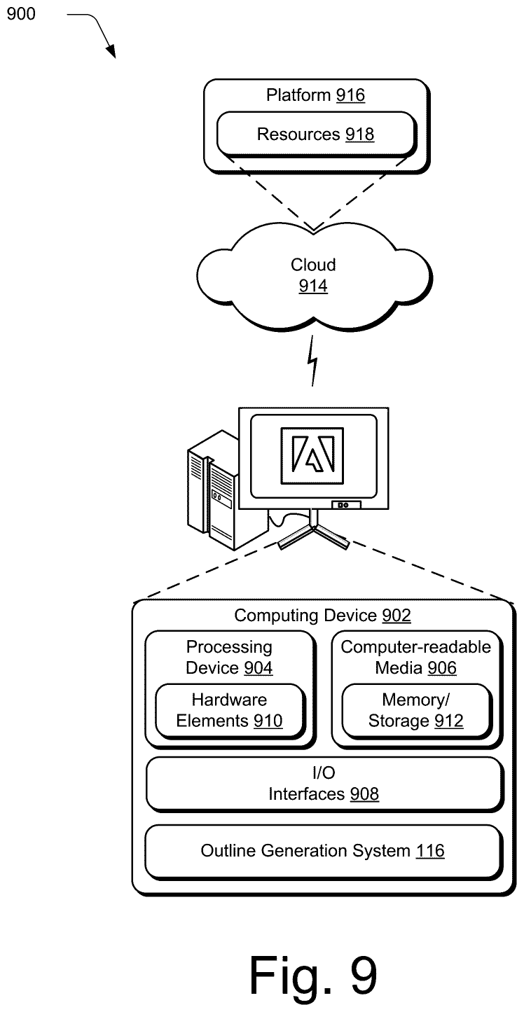

The computing device 102, for instance, is configurable as a desktop computer, a laptop computer, a mobile device (e.g., assuming a handheld configuration such as a tablet or mobile phone as illustrated), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 9.

The computing device 102 is illustrated as including an image processing system 104. The image processing system 104 is implemented at least partially in hardware of the computing device 102 to process and transform a digital image 106, which is illustrated as maintained in a storage device 108 of the computing device 102. Such processing includes creation of the digital image 106, modification of the digital image 106, and rendering of the digital image 106 in a user interface 110 for output, e.g., by a display device 112. Although illustrated as implemented locally at the computing device 102, functionality of the image processing system 104 is also configurable as whole or in part via functionality available via the network 114, such as part of a web service or “in the cloud.”

An example of functionality incorporated by the image processing system 104 to process a digital image 106 is illustrated as an outline generation system 116. The outline generation system 116 is configured to take, as an input, a digital image 106, and from the digital image 106, generate an image outline 118. The image outline 118 is configurable to utilize line segments to represent edges (e.g., boundaries) and other portions of objects included in digital images.

In order to improve accuracy in generation of the image outline 118, the outline generation system 116 includes a context detection module 120 that is configured to detect a context exhibited by the digital image 106, e.g., using machine learning. Based on the detected context, the context detection module 120 employs a context processing unit 122 to select a context processing module 124 from a plurality of context processing modules. Each context processing module 124 is configured to generate an image outline 118 that is optimized for a respective context. Accordingly, the context processing modules are representative of respective image editing pipelines to achieve an output consistent with user expectations, automatically and without user intervention.

In a first example, a first digital image 106(1) as displayed in the user interface 110 is used as a basis by the outline generation system 116 to generate a first image outline 118(1) based on edges of flowers and grass included in an outdoor scene. In a second example, a second digital image 106(2), as displayed in the user interface 110, is used as a basis by the outline generation system 116 to generate a second image outline 118(2) based on edges of furniture and walls of a house as part of an indoor scene. Other examples are also contemplated, such as to generate an image outline 118 based on detecting that the digital image 106 includes a salient object.

In this way, the context detection module 120 and context processing unit 122 are configured to adapt to visual nuances of different contexts exhibited by the digital image 106 to generate a corresponding image outline 118. These techniques, for instance, are configurable to provide a desired level of detail in the image outline 118 to convey objects included in the digital image 106 in the different contexts, automatically and without user intervention. Further discussion of these and other examples is included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Digital Image Outline Generation Techniques

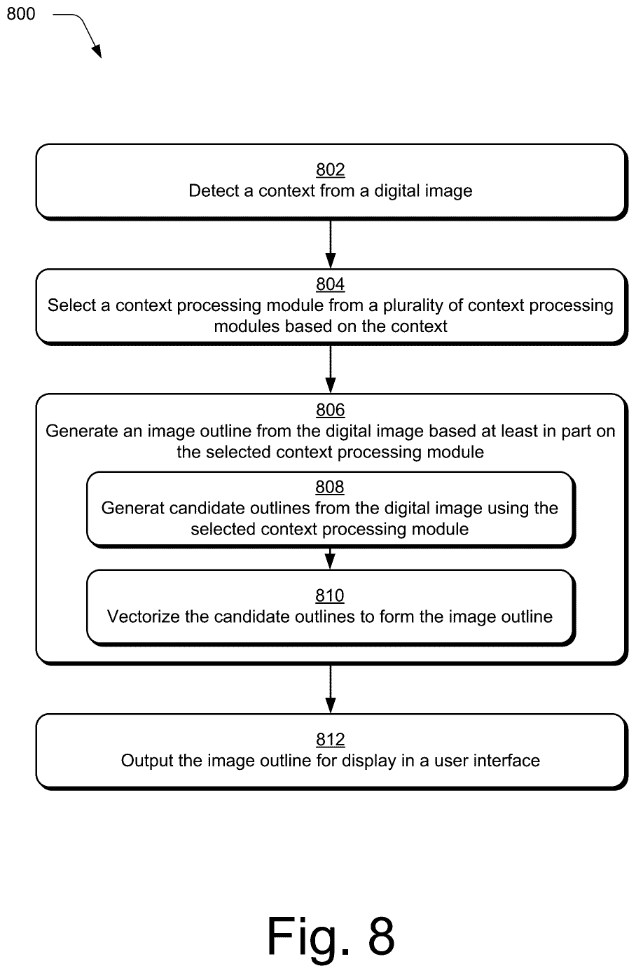

The following discussion describes digital image outline techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 8 is a flow diagram depicting an algorithm 800 as a step-by-step procedure in an example implementation of operations performable for accomplishing a result of generating a digital image outline from a digital image based on a context exhibited by the digital image. In portions of the following discussion, reference will be made in parallel to FIG. 8.

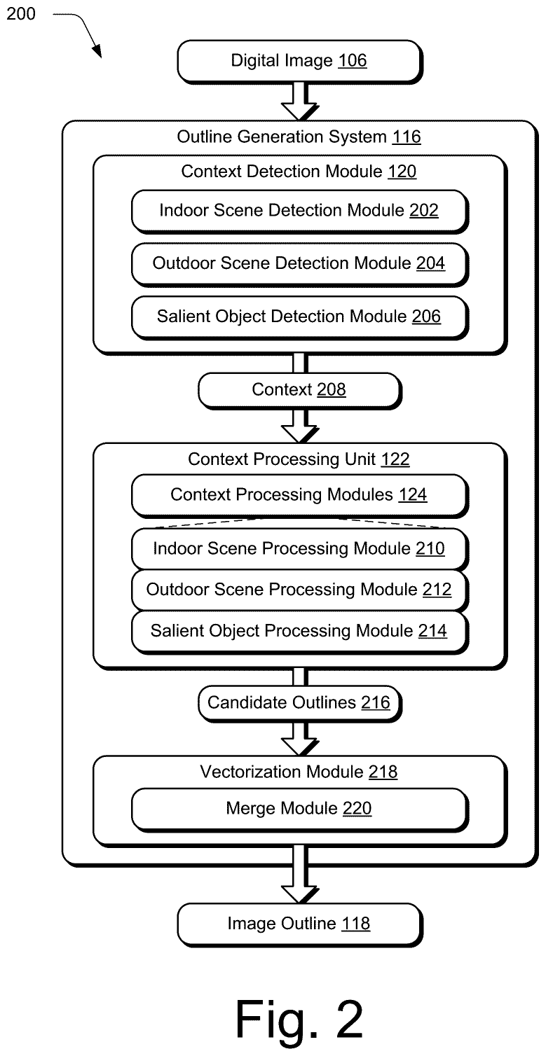

FIG. 2 depicts a system 200 in an example implementation showing operation of the context detection module 120 and the context processing unit 122 of the outline generation system 116 of FIG. 1 in greater detail. The context detection module 120 is configured to detect a context from a digital image (block 802). To do so, the context detection module 120 may employ a variety of functionality, an example of which includes use of a machine-learning model.

A machine-learning model refers to a computer representation that is tunable (e.g., through training and retraining) based on inputs without being actively programmed by a user to approximate unknown functions, automatically and without user intervention. In particular, the term machine-learning model includes a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

The machine-learning model, for instance, is trained using training data collected as positive and negative examples of a particular goal, for which, the model is to be trained. The training data provides examples of “what is to be learned” by the machine-learning model during training. The training data, for instance, is usable to identify positive and negative examples (e.g., through labeling) for an indoor scene, an outdoor scene, inclusion of salient objects, and so on as represented for the indoor scene detection module 202, an outdoor scene detection module 204, a salient object detection module 206, and so on.

The machine-learning system, for instance, collects and preprocesses the training data that includes input features and corresponding target labels, i.e., of what is exhibited by the input features, e.g., the indoor scene, the outdoor scene, salient objects, and so forth. Parameters of the machine-learning model are initialized, which are used by the machine-learning model as internal variables to represent and process information during training and represent interferences gained through training. In an implementation, the training data is separated into batches to improve processing and optimization efficiency of the parameters of the machine-learning model during training.

The training data is then used as a basis for generating predictions based on a current state of parameters of layers and corresponding nodes of the model, a result of which is output as output data. Output data describes an outcome of the task, e.g., as a probability of being a member of a particular class in a classification scenario to classify the digital image as including an indoor scene, an outdoor scene, a salient object, and so forth.

Training of the machine-learning model includes calculating a loss function to quantify a loss associated with operations performed by nodes of the machine-learning model. The calculating of the loss function, for instance, includes comparing a difference between predictions specified in the output data with target labels specified by the training data. The loss function is configurable in a variety of ways, examples of which include regret, Quadratic loss function as part of a least squares technique, and so forth.

Calculation of the loss function also includes use a backpropagation operation as part of minimizing the loss function and thereby training parameters of the machine-learning model. Minimizing the loss function, for instance, includes adjusting weights of the nodes in order to minimize the loss and thereby optimize performance of the machine-learning model in performance of a particular task, e.g., to classify a context of the digital image 106. The adjustment is determined by computing a gradient of the loss function, which indicates a direction to be used in order to adjust the parameters to minimize the loss. The parameters of the machine-learning model are then updated based on the computed gradient.

This process continues over a plurality of iterations in an example until a stopping criterion is met. The stopping criterion is employed in this example to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, or based on performance metrics such as precision and recall.

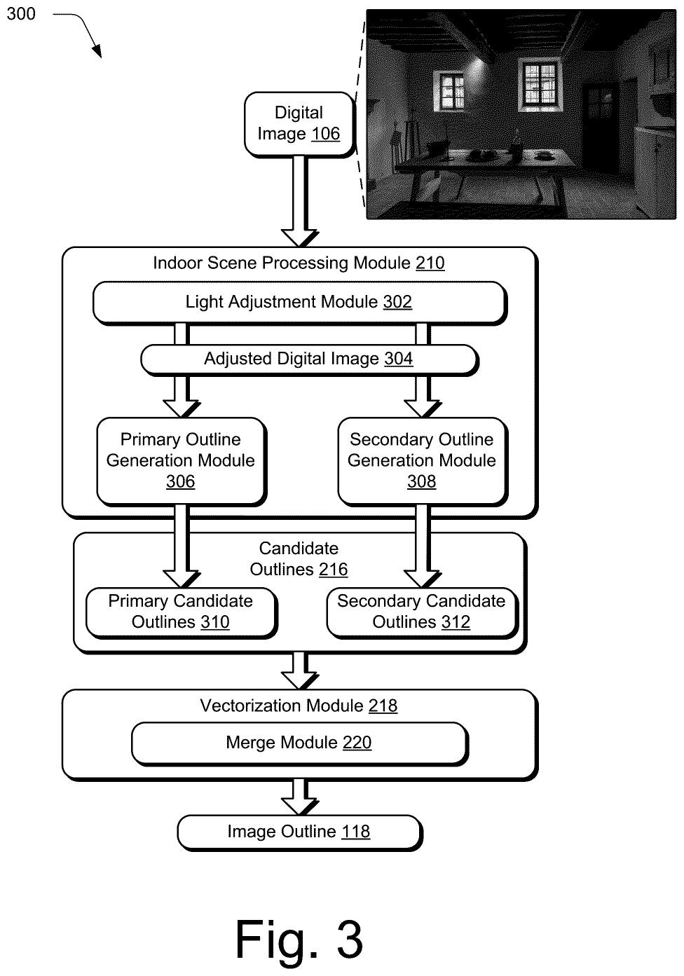

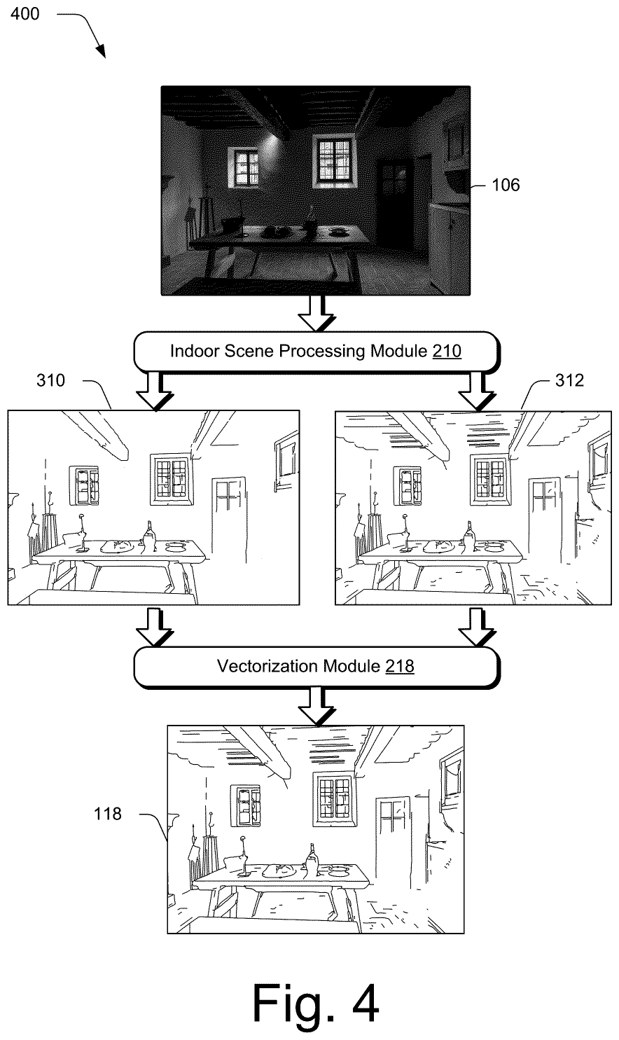

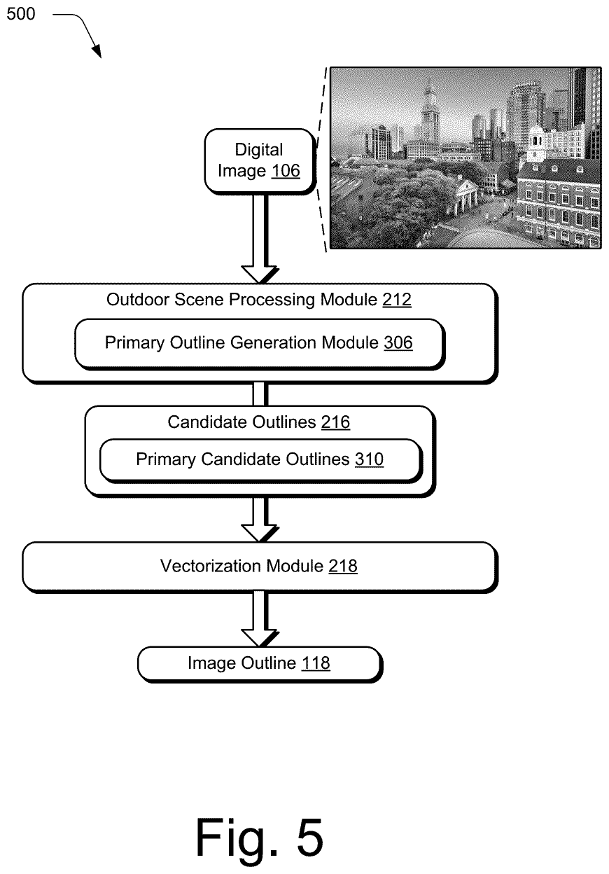

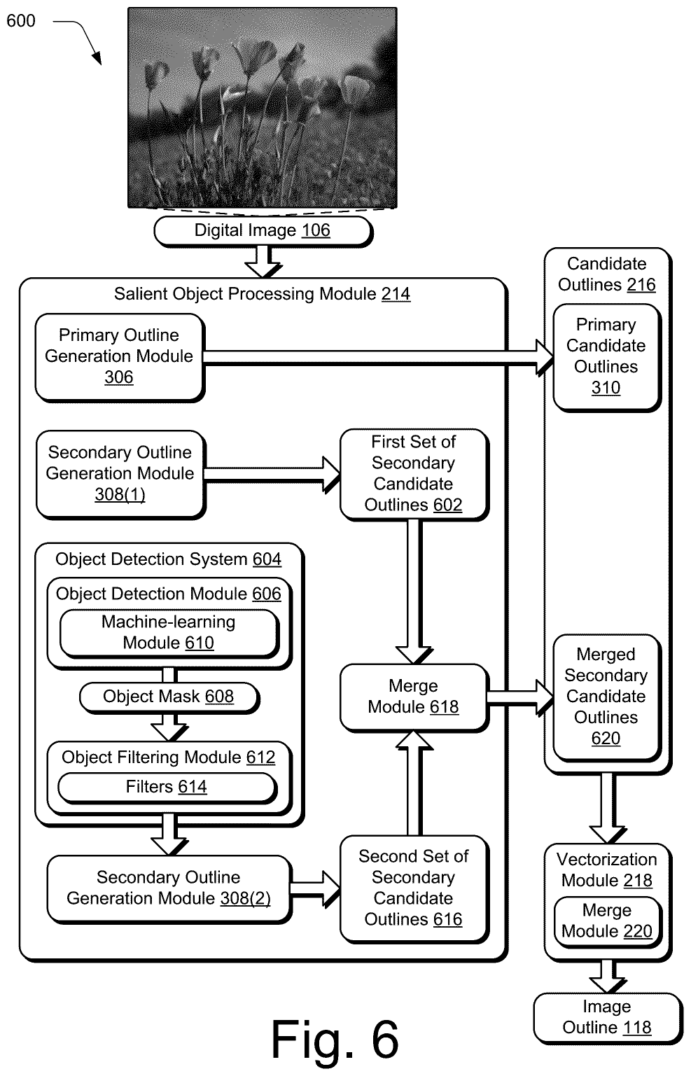

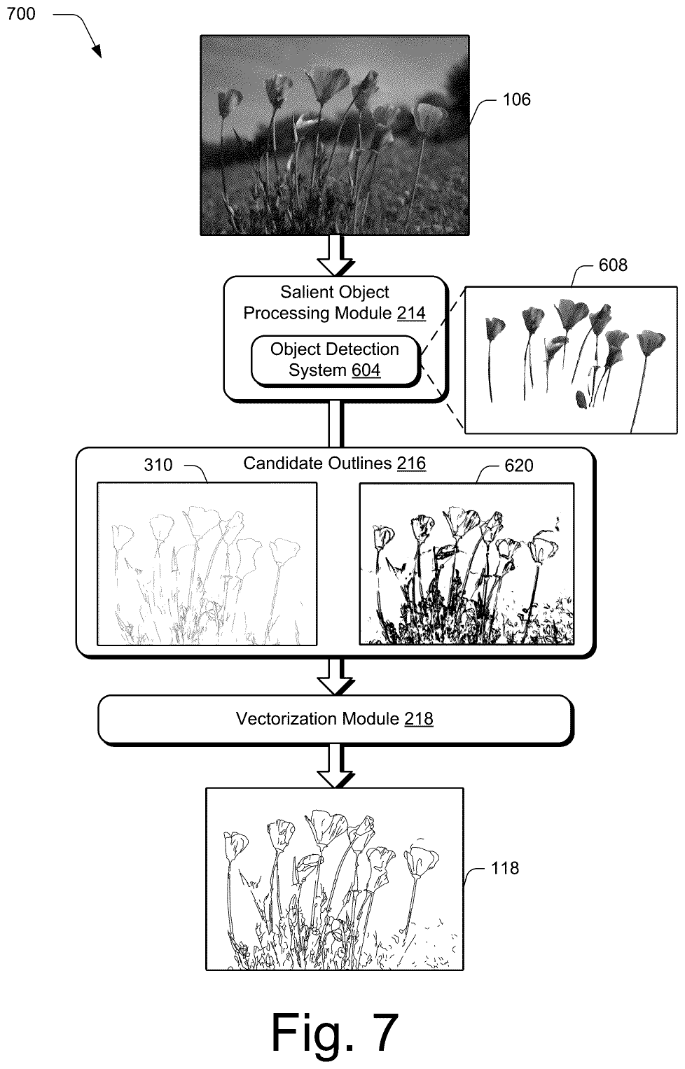

Through use of the machine-learning model once trained in this example, the context detection module 120 is configured to detect a context 208 exhibited by the digital image 106. The context processing unit 122 is then configured to select a context processing module from a plurality of context processing modules 124 based on the context (block 804). Illustrated examples of context processing modules include an indoor scene processing module 210, an outdoor scene processing module 212, and a salient object processing module 214. Further discussion of operation of the indoor scene processing module 210 is described in relation to FIGS. 3 and 4, the outdoor scene processing module 212 is described in relation to FIG. 5, and the salient object processing module 214 is described in relation to FIGS. 6 and 7.

The context processing unit 122 is configured to generate the image outline 118 from the digital image 106 based at least in part on the selected context processing module (block 806). The context processing unit 122, for instance, generates candidate outlines 216 from the digital image 106 using a selected context processing module (block 808), e.g., as raster objects such as a bitmap. The candidate outlines 216 are then vectorized by a vectorization module 218 to form the image outline (block 810). The vectorization module 218, for instance, is configurable to employ thresholding to convert the candidate outlines 216 into a black-and-white image using a threshold to determine whether to set a value of the pixels as black or white. The raster objects in the black-and-white image are then used as a basis to detect line segments to define Bezier curves, e.g., using a Hough transform, polygon approximation, skeletonization, template matching, use of a machine-learning model, and so forth.

The context 208, in one or more examples, is configurable to define more than one context. In those examples, the context processing unit 122 is configurable to utilize multiple context processing modules 124 in generation of candidate outlines 216. The candidate outlines 216 are then merged by the merge module 220 as part of vectorization by the vectorization module 218 to form the image outline 118.

As part of generating the vector objects, the vectorization module 218 may also employ a variety of support functionality, such as a merge module 220 to merge line segments, remove noise, remove duplicates, and so forth. The image outline 118 is then output (block 812) by the outline generation system 116, e.g., for display in a user interface 110. In this way, the outline generation system 116 is configured to address context of a digital image 106 as a guide toward generation of the image outline 118 which improves accuracy.

FIG. 3 depicts a system 300 in an example implementation showing operation of the indoor scene processing module 210 of FIG. 2 in greater detail. In this example, the digital image 106 has been detected by the context detection module 120 as exhibiting an indoor scene. The indoor scene processing module 210, accordingly, receives the digital image 106. A light adjustment module 302 is first employed to generate an adjusted digital image 304 by adjusting light values of respective pixels within the digital image 106. The adjusted digital image 304, for instance, is configured to have normalized light values, such as to further illuminate objects included in dark portions of the indoor scene.

The adjusted digital image 304 is then passed as an input to a primary outline generation module 306 and a secondary outline generation module 308. The primary outline generation module 306 is configured to generate primary candidate outlines 310 from the digital image 106. To do so, the primary outline generation module 306 is configurable to employ a first machine-learning model that has been trained and retrained using training data over cleaned edge results from a plurality of training digital images. The first machine-learning model, once trained, is configured to generate a raster image having “clean” primary outlines. A second machine-learning model is then employed by the primary outline generation module 306 to further clean the primary outlines (e.g., by removing noise), an output of which is the primary candidate outlines 310.

The secondary outline generation module 308 is configured to generate secondary candidate outlines 312 from the digital image 106. To do so, the secondary outline generation module 308 is configurable as implemented in an image processing pipeline using a graphics processing unit (GPU). The secondary outline generation module 308, for instance, is configured to employ a variety of filters through different configurations to generate high accuracy and low accuracy secondary candidate outlines 312. In a first example, a bilinear scaling filter is used to reduce texture size to improve responsiveness of the pipeline and reduce hardware noise, e.g., using a scaling value of one-half.

In a second example, a bilateral filter is used that is an example of a non-linear, edge preserving and noise reducing smoothening filter for digital images. In an implementation, the color of each pixel is replaced with a weighted average of colors from nearby pixels. The weight assigned to a neighboring pixel is proportional to its spatial and color closeness with the pixel in consideration. For each pixel “p,” for instance, weights are calculated for each of the neighboring pixels in a five-pixel radius.

In a third example, an RGB-to-luminance filter is employed by the secondary outline generation module 308 to convert an RGB channel of each pixel to a single luminance value. Use of a single luminance value per pixel boosts overall pipeline performance and reduces complexity in operation of the secondary outline generation module 308.

In a fourth example, an edge detection filter is used, e.g., a Sobel filter. A Sobel-Feldman operator, for instance, is used to process each pixel to locate edges within the digital image 106.

In a fifth example, a levels-adjustment filter is used by the secondary outline generation module 308 to set output levels fixed at “0” (i.e., pure black color) and “255,” i.e., for a pure white color. Midtones are fixed at “0.7,” with low-end tones and high-end tones evenly spaced, e.g., spaced apparat by a value of “0.15” in a scenario in which normalized values are scaled between values of zero and one.

In a sixth example, the secondary outline generation module 308 employs a Gaussian blur filter. The Gaussian blur filter is used to remove noise artifacts. In combination with a threshold filter, the Gaussian blur filter achieves sharp secondary candidate outlines 312 in real world scenarios.

In a seventh example, a binary threshold filter is employed by the secondary outline generation module 308 to segment the digital image and decide, at each pixel, whether the pixel is to be passed as part of the secondary candidate outlines 312. In an eighth example, the secondary outline generation module 308 also employs a median filter as a noise removal filter to remove impulsive, random, and/or salt-pepper noise while preserving edges as part of forming the secondary candidate outlines 312.

The candidate outlines 216 including the primary candidate outlines 310 and the secondary candidate outlines 312 are then output to a vectorization module 218 in this example for vectorization. As part of this, a merge operation is executed by the merge module 220 to combine the primary candidate outlines 310 and the secondary candidate outlines 312 to generate a single set of vector outlines.

The vectorization module 218, for instance, employs an image trace technique that implements internal logic curve fitting and vector smoothening. Therefore, given an input image defining the candidate outlines 216, the vectorization module 218 is employable to generate single line vectors having stroke properties such as stroke width, type, taper, and so on. Through definition as vector objects, the image outline 118 is scalable to a desired resolution. Duplication operations are also usable by the vectorization module 218 as part of generating the image outline 118, e.g., to generate a snapshot of a current vector output on a canvas which is then again vectorized to generate the image outline 118.

FIG. 4 depicts examples 400 of generation of primary candidate outlines and secondary candidate outlines by the indoor scene processing module 210 of FIG. 3 which are then merged to form an image outline. The digital image 106 is received by the indoor scene processing module 210, which generates primary candidate outlines 310 depicting higher level details than those captured by the secondary candidate outlines 312. A vectorization module 218 is then utilized to generate the image outline 118 by merging the primary candidate outlines 310 and the secondary candidate outlines 312, which provides a balance of high and low level details as consistent with user expectations for an indoor scene.

FIG. 5 depicts a system 500 in an example implementation showing operation of the outdoor scene processing module 212 of FIG. 2 in greater detail. In this example, the digital image 106 has been detected by the context detection module 120 as exhibiting an outdoor scene. The outdoor scene processing module 212, accordingly, receives the digital image 106 and generates the image outline 118.

To do so in this example, the outdoor scene processing module 212 employs the primary outline generation module 306, alone, to generate the candidate outlines 216 as having the primary candidate outlines 310 but not the secondary candidate outlines 312. Therefore, the outdoor scene processing module 212 employees the primary outline generation module 306 independent of the secondary outline generation module 308 to generate the candidate outlines 216, which improves operational efficiency and reduces computational resource consumption when compared with conventional single-approach techniques.

The candidate outlines 216, as raster objects, are then vectorized by the vectorization module 218 to form the image outline 118. In this way, the image outline 118 follows user expectations generating of the image outline 118 for an outdoor scene by following edges of primary objects within the scene without introducing secondary outlines that may add to noise when viewed as part of the image outline 118.

FIG. 6 depicts a system 600 in an example implementation showing operation of the salient object processing module 214 of FIG. 2 in greater detail. In this example, the digital image 106 has been detected by the context detection module 120 as exhibiting a salient object, e.g., based on use of a machine-learning model as described in relation to FIG. 2. The salient object processing module 214 employs a primary outline generation module 306 as well as a first instance of the secondary outline generation module 308 of FIG. 3, which is illustrated as secondary outline generation module 308(1).

The primary outline generation module 306, as previously described, is configured to generate primary candidate outlines 310 from the digital image 106 as part of the candidate outlines 216. To do so, the primary outline generation module 306 is configurable to employ a first machine-learning model that has been trained and retrained using training data over cleaned edge results from a plurality of training digital images. The first machine-learning model, once trained, is configured to generate a raster image having “clean” primary outlines.

A second machine-learning model is then employed by the primary outline generation module 306 to further clean the primary outlines (e.g., by removing noise), an output of which is the primary candidate outlines 310.

The secondary outline generation module 308(1) is configured to generate a first set of secondary candidate outlines 602 from the digital image 106. To do so, the secondary outline generation module 308(1) is configurable as implemented in an image processing pipeline using a graphics processing unit (GPU). The secondary outline generation module 308(1), for instance, is configured to employ a variety of filters through different configurations to generate high accuracy and low accuracy secondary candidate outlines 312. Examples of the filters include a bilinear scaling filter, a bilateral filter, an RGB-to-luminance filter, an edge detection filter, a levels-adjustment filter, a Gaussian blur filter, a binary threshold filter, a median filter, and so on.

The salient object processing module 214 also includes an object detection system 604 to address a context of the digital image 106 as having a salient object. To do so, an object detection module 606 is employed to generate an object mask 608 using a machine-learning model 610. The machine-learning model 610, for instance, is configurable as a mask-region based convolutional neural network that is trained and retrained using training data to take the digital image 106 as an input and return the object mask 608.

Once the object mask 608 is generated by the object detection module 606, an object filtering module 612 is employed to utilize one or more filters 614 to further process the object mask 608. The object mask is then filtered (e.g., using an erosion filter, dilation filter, and so on) in one or more examples to smooth edges of the object mask, an example of which is described as follows.

```
Begin:
  Convert mask into Matrix:
    mask.convertTo(mask, CV_8UC4, 1.f/255.f);
    src_img_original.convertTo(src_img_original, CV_8UC4);
    src_img_original.copyTo(result, mask);
  Dilate:
    auto kernel = cv::getStructuringElement(cv::MORPH_ELLIPSE,
  cv::Point
  (5, 5));
    Blur out dilatation
      cv::GaussianBlur(result, result, cv::Size(5, 5), 0);
    Erodeout:
      cv::erode(erodedMask, erodedMask, kernel);
      erodedMask.convertTo(erodedMask, CV_8UC4, 1.f / 255.f);
    End:
```

The first set of secondary candidate outlines 602 and the second set of secondary candidate outlines 616 are output to a merge module 618 to form a merged secondary candidate outlines 620. The candidate outlines 216 including the primary candidate outlines 310 and the merged secondary candidate outlines 620 are then output to a vectorization module 218 to form the image outline 118.

The vectorization module 218, for instance, employs an image trace technique as previously described that implements internal logic curve fitting and vector smoothening. Therefore, given the candidate outlines 216, the vectorization module 218 is employable to generate single line vectors having stroke properties such as stroke width, type, taper, and so on. Through definition as vector objects, the image outline 118 is scalable to a desired resolution. Duplication operations are also usable by the vectorization module 218 as part of generating the image outline 118, e.g., to generate a snapshot of a current vector output on a canvas which is then again vectorized to generate the image outline 118. A variety of other examples are also contemplated.

FIG. 7 depicts examples 700 of generation of primary candidate outlines and secondary candidate outlines by the salient object processing module 214 of FIG. 6 which are then merged to form an image outline. The digital image 106 is received by salient object processing module 214, which generates primary candidate outlines 310 depicting fewer details than those captured by the merged secondary candidate outlines 620. A vectorization module 218 is then utilized to generate the image outline 118 by merging the primary candidate outlines 310 and the merged secondary candidate outlines 620, which again provides a balance of high and low level details as consistent with user expectations for a digital image having a context of a salient object.

In this way, the image outline is generated automatically and without user intervention in real time by the outline generation system as optimized based on a context detected from the digital image, which is not possible in conventional techniques.

### Example System and Device

FIG. 9 illustrates an example system generally at 900 that includes an example computing device 902 that is representative of one or more computing systems and/or devices that implement the various techniques described herein. This is illustrated through inclusion of the outline generation system 116. The computing device 902 is configurable, for example, as a server of a service provider, a device associated with a client (e.g., a client device), an on-chip system, and/or any other suitable computing device or computing system.

The example computing device 902 as illustrated includes a processing device 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 904 is representative of functionality to perform one or more operations using hardware. Accordingly, the processing device 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912 that stores instructions that are executable to cause the processing device 904 to perform operations. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing device 904. The instructions and/or functions are executable/operable by one or more articles of manufacture (for example, one or more computing devices 902 and/or processing devices 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

In implementations, the platform 916 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
detecting, by a processing device, a context from a digital image;
selecting, by the processing device, a context processing module from a plurality of context processing modules based on the context;
generating, by the processing device, an image outline from the digital image based at least in part on the selected context processing module; and
outputting, by the processing device, the image outline for display in a user interface.

2. The method as described in claim 1, wherein the detecting of the context is performed for a plurality of contexts, each said context defining a respective setting in how the digital image is perceived.

3. The method as described in claim 2, wherein the context includes an indoor scene, an outdoor scene, or a salient object.

4. The method as described in claim 3, wherein a first said context processing module corresponds to the indoor scene, a second said context processing module corresponds to the outdoor scene, and a third-said context processing module corresponds to the salient object.

5. The method as described in claim 1, wherein the generating of the image outline includes generating candidate outlines from the digital image using the selected context processing module and vectorizing the candidate outlines to form the image outline.

6. The method as described in claim 5, wherein the generating of the image outline includes merging the candidate outlines to form the image outline.

7. The method as described in claim 6, wherein the generating of the image outline includes removing duplicates to form the image outline.

8. The method as described in claim 1, wherein the selected context processing module is configured to perform operations including:
generating primary candidate outlines using a primary outline generation module;
generating secondary candidate outlines using a secondary outline generation module; and
merging the primary candidate outlines and the secondary candidate outlines to form the image outline.

9. The method as described in claim 8, wherein the selected context processing module is further configured to perform operations including generating an adjusted digital image by adjusting light values of the digital image.

10. The method as described in claim 8, wherein a second said context processing module corresponding to a second said context is configured to generate the image outline using the primary outline generation module independent of use of the secondary outline generation module.

11. The method as described in claim 1, wherein the selected context processing module is configured to perform operations including:
generating primary candidate outlines using a primary outline generation module;
generating a first set of secondary candidate outlines using a secondary outline generation module;
generating a second set of secondary candidate outlines based at least in part on object detection implemented using a machine-learning model; and
generating the image outline based on the primary candidate outlines, the first set of secondary candidate outlines, and the second set of secondary candidate outlines.

12. The method as described in claim 11, wherein the second set of secondary candidate outlines are generated based on an object mask generated from the digital image.

13. The method as described in claim 12, further comprising removing noise from the object mask.

14. A computing device comprising:
a processing device; and
a computer-readable storage medium storing instructions that, responsive to execution by the processing device, causes the processing device to perform operations including:
detecting a context from a digital image;
selecting a context processing module from a plurality of context processing modules based on the context;
generating an image outline from the digital image based at least in part on the selected context processing module.

15. The computing device as described in claim 14, wherein the detecting of the context is performed for a plurality of contexts, each said context defining a respective setting in how the digital image is perceived.

16. The computing device as described in claim 14, wherein a first said context processing module corresponds to an indoor scene, a second said context processing module corresponds to an outdoor scene, and a third-said context processing module corresponds to a salient object.

17. The computing device as described in claim 14, wherein the generating of the image outline includes generating candidate outlines from the digital image using the selected context processing module and vectorizing the candidate outlines to form the image outline.

18. The computing device as described in claim 14, wherein the selected context processing module is configured to perform operations including:
generating primary candidate outlines using a primary outline generation module;
generating a first set of secondary candidate outlines using a secondary outline generation module;
generating a second set of secondary candidate outlines based at least in part on object detection implemented using a machine-learning model; and
generating the image outline based on the primary candidate outlines, the first set of secondary candidate outlines, and the second set of secondary candidate outlines.

19. One or more computer-readable storage media storing instructions that, responsive to execution by a processing device, causes the processing device to perform operations including:
selecting a context processing module from a plurality of context processing modules based on a context of a digital image, the plurality of context processing modules including a first said context processing module corresponding to an indoor scene, a second said context processing module corresponding to an outdoor scene, and a third-said context processing module corresponding to a salient object; and
generating an image outline from the digital image based at least in part on the selected context processing module.

20. The one or more computer-readable storage media as described in claim 19, wherein the generating of the image outline includes generating candidate outlines from the digital image using the selected context processing module and vectorizing the candidate outlines to form the image outline.
